(19) United States
(12) Patent Application Publication
(10) Pub. No.: US 2005/0252786 A1
(43) Pub. Date: Nov. 17, 2005

(54) Electrolytic process and apparatus

(76) Inventor: Felice DiMascio, Rocky Hill, CT (US)

Correspondence Address: CANTOR COLBURN, LLP, 55 GRIFFIN ROAD SOUTH, BLOOMFIELD, CT, 06002, US

(21) Appl. No.: 10/514,175

(22) PCT Filed: Jul. 17, 2002
(86) PCT No.: PCT/US02/22830

§ 371 Date: Nov. 11, 2004

(51) Int. Cl. C25C 7/00; C25D 17/00; B01D 61/46

(52) U.S. Cl. 205/499; 204/632; 204/252; 205/556

(57) ABSTRACT

An electrolytic process and apparatus (20) for oxidizing inorganic or organic species is disclosed. The process and apparatus includes contacting a solution containing the inorganic or organic species with an electrocatalytic material disposed in the electrolytic reactor (200). Also disclosed is a process for fabricating a ceramic catalyst material for use in the electrolytic reactors (200) and processes.

### BACKGROUND OF THE INVENTION

This disclosure relates to an electrochemical method and apparatus, more particularly, relates to an oxidation and reduction process and even more particularly, relates to an improved system and process for producing chlorine dioxide.

With the decline of gaseous chlorine as a microbiocide and bleaching agent, various alternatives have been explored, including bleach, bleach with bromide, bromo-chlorodimethyl hydantoin, ozone, and chlorine dioxide (ClO₂). Of these, chlorine dioxide has generated a great deal of interest for control of microbiological growth in a number of different industries, including the dairy industry, the food and beverage industry, the pulp and paper industries, the fruit and vegetable processing industries, various canning plants, the poultry industry, the beef processing industry and miscellaneous other food processing applications. Chlorine dioxide is also seeing increased use in municipal potable water treatment facilities, potable water pathogen control in office building and healthcare facilities, industrial cooling loops, and in industrial waste treatment facilities, because of its selectivity towards specific environmentally-objectionable waste materials, including phenols, sulfides, cyanides, thiosulfates, and mercaptans. In addition, chlorine dioxide is being used in the oil and gas industry for downhole applications as a well stimulation enhancement additive.

Unlike chlorine, chlorine dioxide remains a gas when dissolved in aqueous solutions and does not ionize to form weak acids. This property is at least partly responsible for the biocidal effectiveness of chlorine dioxide over a wide pH range, and makes it a logical choice for systems that operate at alkaline pHs or that have poor pH control. Moreover, chlorine dioxide is a highly effective microbiocide at concentrations as low as 0.1 parts per million (ppm) over a wide pH range.

The biocidal activity of chlorine dioxide is believed to be due to its ability to penetrate bacterial cell walls and react with essential amino acids within the cell cytoplasm to disrupt cell metabolism. This mechanism is more efficient than other oxidizers that “burn” on contact and is highly effective against legionella, algae and amoebal cysts, giardia cysts, coliforms, salmonella, shigella, and cryptosporidium.

Unfortunately, chlorine dioxide can become unstable and hazardous under certain temperature and pressure conditions. Although this is only an issue of concern for solutions of relatively high concentration, its shipment, at any concentration, is banned. It is for this reason that chlorine dioxide is always generated on-site, at the point of use, usually from a metal chlorate or metal chlorite as an aqueous solution. For example, a metal chlorite solution mixed with a strong acid can be used to generate chlorine dioxide in situ.

Electrochemical processes provide a means for generating chlorine dioxide for point of use applications. For example, U.S. Pat. No. 5,419,816 to Sampson et al. describes a packed bed ion exchange electrolytic system and process for oxidizing species in dilute aqueous solutions by passing the species through an electrolytic reactor packed with a monobed of modified cation exchange material. A similar electrolytic process is described in U.S. Pat. No. 5,609,742 to Sampson et al. for reducing species using a monobed of modified anion exchange.

One difficulty with electrochemical processes is that it can be difficult to control the generation of undesirable species. For example, there are many electrochemical reactions that can occur at the anode. Within a potential range of 0.90 to 2.10 volts, at least eight different reactions are thermodynamically possible, producing products such as chlorate (ClO₃⁻), perchlorate (ClO₄⁻), chlorous acid (HClO₂), oxygen (O₂), hydrogen peroxide (H₂O₂) and ozone (O₃). It is highly desirable and a significant commercial advantage for an apparatus to allow for careful control of the products generated to achieve high yield efficiency.

Chlorine dioxide has also been produced from a chlorine dioxide precursor solution by contacting the precursor solution with a catalyst (e.g., catalysts containing a metal such as those catalysts described for example in U.S. Pat. No. 5,008,096) in the absence of an electrical field or electrochemical cell. However, known catalytic processes have the disadvantage of becoming greatly deactivated within a matter of days. Moreover, it has been found that the support materials for the catalytic sites tend to quickly degrade due to the oxidizing nature of chlorine dioxide. Still further, the use of catalyst materials in packed columns or beds for generating chlorine dioxide has been found to cause a significant pressure drop across the column or form channels within the column that results in a significant decrease in conversion efficiency from the chlorine dioxide precursor to chlorine dioxide. It is also noted that catalyst materials are relatively expensive and can add significant cost to an apparatus employing these materials.

### SUMMARY OF THE INVENTION

Disclosed herein is a system and apparatus for producing a halogen oxide such as chlorine dioxide. The system comprises an electrolytic reactor comprising a compartment having an inlet and an outlet, an anode, a cathode, and a particulate material disposed between the cathode and the anode, wherein the particulate material comprises a cation exchange material; a source of direct current in electrical communication with the anode and the cathode; and a fixed bed reactor comprising a chamber having an inlet and an outlet, wherein the fixed bed reactor chamber contains a redox exchanger material, and wherein the fixed bed reactor inlet is in fluid communication with the electrolytic reactor outlet.

A process for producing halogen oxide comprises feeding an aqueous alkali metal halite solution into an electrolytic reactor to produce an effluent containing halous acid; feeding the halous acid containing effluent into a fixed bed reactor containing a redox exchanger material; and contacting the halous acid containing effluent with the redox exchanger material to produce a halogen oxide.

In another embodiment, a process for producing for producing chlorine dioxide from an alkali metal chlorite solution comprises applying a current to an electrolytic reactor, wherein the electrolytic reactor includes an anode compartment comprising an anode, a cathode compartment comprising a cathode, and a central compartment positioned between the anode and cathode compartments, wherein the central compartment comprises a cation exchange material and is separated from the cathode compartment with a cation exchange membrane; feeding the alkali metal chlorite solution to the central compartment; electrolyzing water in the anode compartment to produce an oxygen containing effluent; exchanging the alkali metal ions with hydrogen ions to produce a chlorous acid containing effluent from the central compartment; combining the chlorous acid effluent with the oxygen containing effluent and feeding the combined effluents to the fixed bed reactor; and oxidizing the chlorous acid with a redox exchanger material in the fixed bed reactor to produce chlorine dioxide and regenerating the redox exchanger material.

In another embodiment, a process for producing chlorine dioxide from an alkali metal chlorite solution comprises applying a current to an electrolytic reactor, wherein the electrolytic reactor includes an anode compartment comprising an anode, a cathode compartment comprising a cathode, and a central compartment positioned between the anode and cathode compartments, wherein the central compartment comprises a cation exchange material and is separated from the cathode compartment with a cation exchange membrane; flowing a solution comprising water in the anode compartment to produce an oxygen containing effluent; diluting an alkali metal chlorite solution with the oxygen containing effluent; feeding the diluted alkali metal chlorite solution to the central compartment; exchanging the alkali metal ions with hydrogen ions to produce a chlorous acid and oxygen containing effluent in the central compartment; feeding the effluent to a fixed bed reactor containing a redox exchanger material; and contacting the effluent with the redox exchanger material in the fixed bed reactor to produce chlorine dioxide and continuously regenerate the redox exchanger material.

In another embodiment, a process for regenerating a fixed bed reactor containing a redox exchanger material comprises electrolyzing water in an electrolytic reactor to produce an oxygen containing effluent; and flowing the oxygen containing effluent into the fixed bed reactor to regenerate the redox exchanger material.

The above-described embodiments and other features will become better understood from the detailed description that is described in conjunction with the accompanying drawings.

### BRIEF DESCRIPTION OF THE DRAWINGS

Referring now to the figures wherein the like elements are numbered alike:

FIG. 1 shows a cross sectional view illustrating a system comprising an electrolytic reactor and a fixed bed reactor;

FIG. 2 shows a cross sectional view illustrating the a single compartment electrolytic reactor;

FIG. 3 shows a cross sectional view illustrating a two-compartment electrolytic reactor;

FIG. 4 shows a cross sectional view illustrating an multi-compartment electrolytic reactor;

FIGS. 5A and 5B show an exploded isometric view of an electrolytic reactor cassette employing the multi-compartment reactor of FIG. 4;

FIG. 6 is a graph showing chlorine dioxide conversion efficiency from an alkali metal chlorite feed solution in the system as shown in FIG. 1 employing a manganese greensand redox exchange media in the fixed bed reactor;

FIG. 7 is a graph showing chlorine dioxide conversion efficiency from an alkali metal chlorite feed solution in the system as shown in FIG. 1 employing PYROLOX® redox exchange media in the fixed bed reactor;

FIG. 8 is a graph showing chlorine dioxide conversion efficiency from an alkali metal chlorite feed solution in the system as shown in FIG. 1 employing BIRM® redox exchange media in the fixed bed reactor; and

FIG. 9 is a graph showing chlorine dioxide conversion efficiency from an alkali metal chlorite feed solution in a system employing a three-compartment electrolytic reactor and a fixed bed reactor containing manganese greensand redox exchange media, wherein an oxidizing agent generated in the anode compartment is not introduced into the fixed bed reactor or the central compartment of the reactor.

### DETAILED DESCRIPTION OF THE PREFERRED EMBODIMENTS

A system and process for producing halogen oxide from alkali metal halite solutions are disclosed, such as, for example, producing chlorine dioxide from an alkali metal chlorite solution. The system and process generally include employing an electrolytic reactor for producing an aqueous effluent containing halous acid and oxygen, which is then fed to a fixed bed reactor containing a redox exchanger material for converting the halous acid to halogen oxide. In a preferred embodiment, the alkali metal halite is an alkali metal chlorite for producing chlorine dioxide. Advantageously, the system provides an economical alternative to other types of systems that utilize expensive catalyst materials. For example, most redox exchanger materials are commercially available at costs of about 35 to about 200 times less than the cost of the precious metal-supported catalyst materials.

In a more preferred embodiment, the alkali metal chlorite solutions are dilute solutions. The term “dilute” refers to aqueous alkali metal chlorite solutions containing less than about 10,000 milligrams alkali metal chlorite per liter of solution (mg/L), preferably less than about 5,000 mg/L, and more preferably less than about 1,500 mg/L. For industrial use, the alkali metal chlorite solution is preferably in the form of a 25% aqueous solution in view of handling property, safety and the like, which can be further diluted during use. Suitable alkali metals include sodium, potassium, lithium, and the like, with preference given to sodium salt considering the commercial availability.

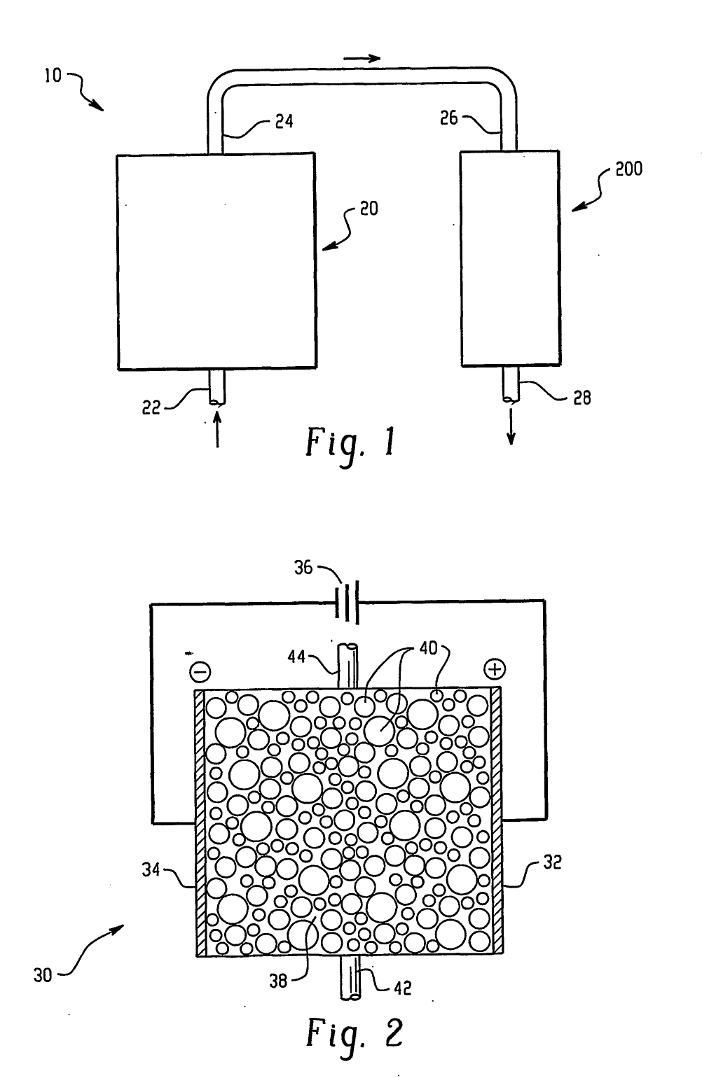

Referring now to FIG. 1, wherein like elements are numbered alike, there is shown a cross-sectional view illustrating a system 10 that generally comprises an electrolytic reactor 20 including an inlet 22 and an outlet 24, wherein the outlet 24 is in fluid communication with an inlet 26 of a fixed bed reactor 200. As will be discussed in greater detail, the system 10 can be utilized for continuously generating an aqueous effluent containing chlorine dioxide from an outlet 28 of the fixed bed reactor 200. For example, an alkali metal chlorite solution can be fed into the inlet of the electrolytic reactor 20 to generate an aqueous effluent containing chlorous acid. The chlorous acid effluent is then fed to inlet 26 of the fixed bed reactor 200, wherein the chlorous acid is oxidized to form chlorine dioxide. An oxidizing agent generated during electrolysis in the electrolytic reactor 20 is additionally directed to the fixed bed reactor 100, individually or in combination with the chlorous acid, to continuously or periodically regenerate the fixed bed reactor 200. In this manner, it has been found that high conversion efficiencies of chlorite ions to chlorine dioxide as well as continuous production can be achieved economically.

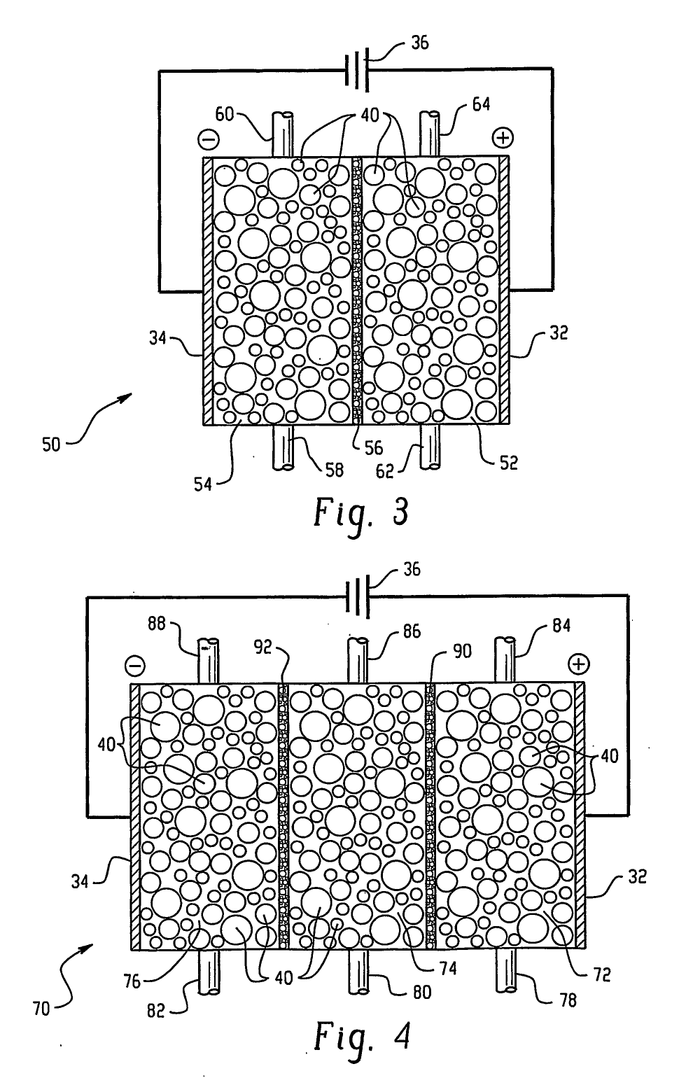

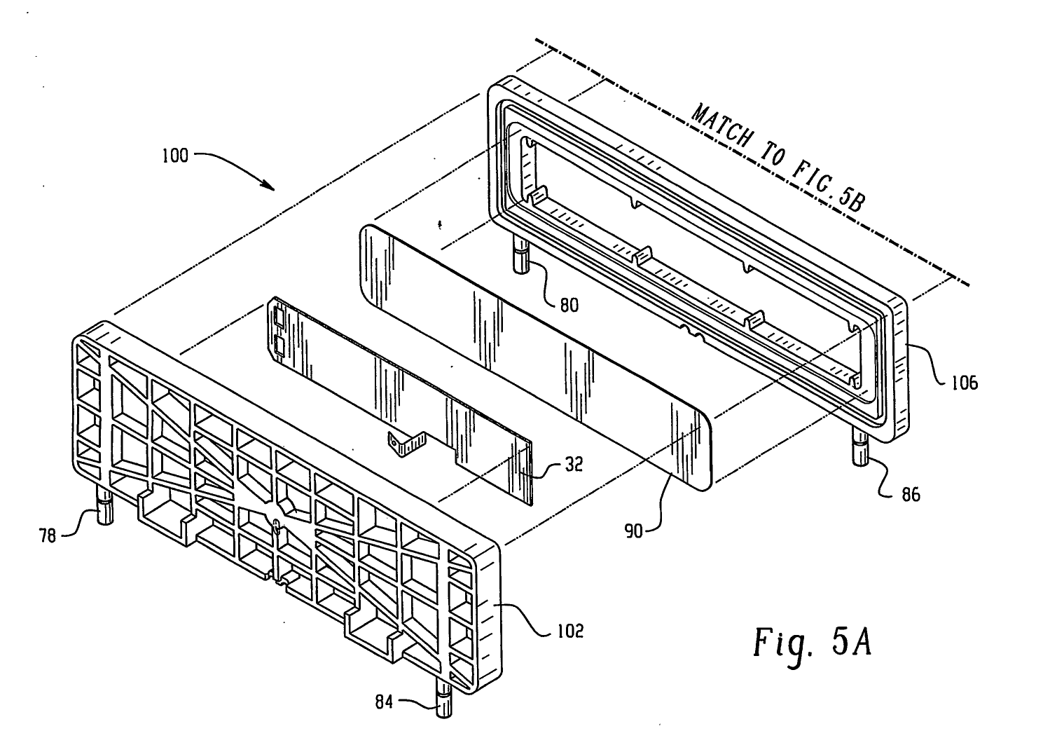

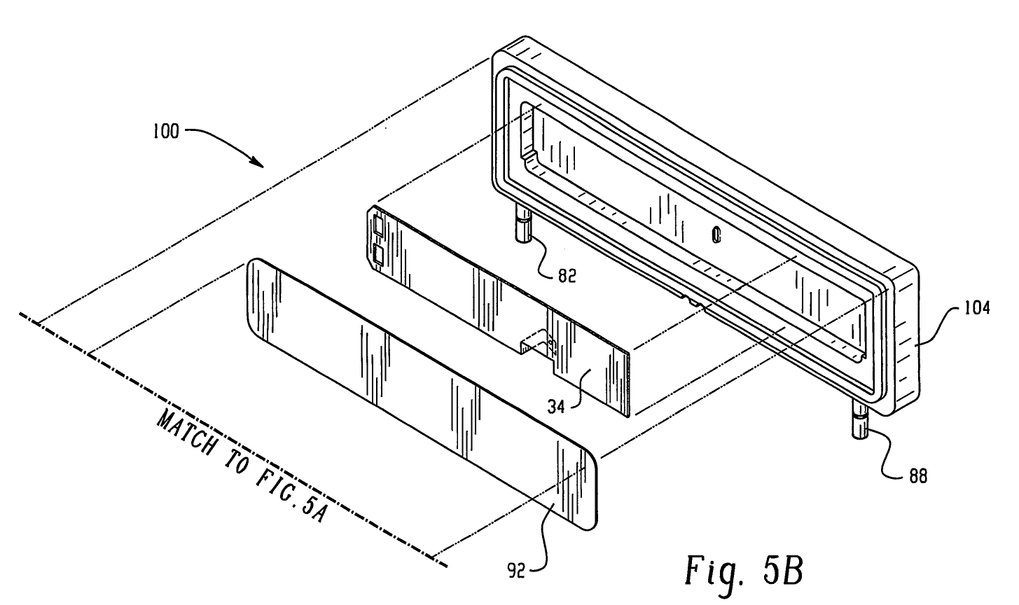

Suitable electrolytic reactors 20 for use in system 10 include a single compartment reactor 30 as shown in FIG. 2, a two-compartment reactor 50 as shown in FIG. 3, or a multi-compartment reactor, i.e., a reactor containing three or more compartments. An exemplary multi-compartment electrolytic reactor 70 configured with three compartments is shown in FIG. 4.

Referring now to FIG. 2, the single compartment electrolytic reactor 30 includes an anode 32 and a cathode 34 in electrical communication with a source of direct current 36 (DC). Interposed between the anode 32 and the cathode 34 exists at least one compartment 38 containing particulate material 40. Compartment 38 further includes an inlet 42 for introducing an alkali metal chlorite feed solution to the electrolytic reactor 30 and an outlet 44 for discharging an effluent from the electrolytic reactor 30.

As used herein, the term “particulate material” refers to a cation exchange material and/or an anion exchange material. Any cation exchange material can be used provided portions of its active sites are occupied with hydrogen, i.e., cation exchange material in the hydrogen form. In a preferred embodiment, the particulate material 40 in compartment 38 includes the cation exchange material or a mixture of the cation exchange material and the anion exchange material. In the case of mixtures of the cation and anion exchange materials, the majority of the particulate material 40 within compartment 38 is preferably the cation exchange material. The particulate material 40 may also include an additive or additives to achieve certain results. For example, electrically conductive particles, such as carbon and the like, can be used to affect the transfer of DC current across electrodes. However, some additives, such as carbon, are prone to disintegration in acidic environments, thus requiring careful selection.

As shown in FIG. 3, the two-compartment electrolytic reactor 50 includes an anode 32, an anode compartment 52, a cathode 34, and a cathode compartment 54, wherein the anode 32 and cathode 34 are in electrical communication with a source of direct current 36 (DC). A membrane 56 preferably separates the anode compartment 52 from the cathode compartment 54. The anode compartment 52 further includes inlet 58 and outlet 60. Similarly, the cathode compartment 54 includes inlet 62 and outlet 64.

As used herein, the term “membrane” generally refers to a sheet for separating adjacent compartments, e.g., compartments 52 and 54. In this regard, the term “membrane” can be used interchangeably with screen, diaphragm, partition, barrier, a sheet, a foam, a sponge-like structure, a canvas, and the like. The membrane 56 can be chosen to be permselective, e.g., a cation exchange membrane, or can be chosen to be non-permselective, e.g., a porous membrane. As used herein, the term “permselective” refers to a selective permeation of commonly charged ionic species through the membrane with respect to other diffusing or migrating ionic species having a different charge in a mixture. In contrast, the term “non-permselective” generally refers to a porous structure that does not discriminate among differently charged ionic species as the species pass through the porous structure, i.e., the membrane is non-selective with respect to ionic species. For example, in a permselective membrane such as a cation exchange membrane, cations can freely pass through the membrane whereas the passage of anions is prevented. In contrast, in a non-permselective membrane such as a porous membrane, the passage of anions and cations through the porous membrane are controlled by diffusion.

At least one of the compartments 52 or 54 of electrolytic reactor 50, contains the particulate material 40, and is configured to receive an aqueous chlorite feed solution. If both compartments contain particulate material 40, each compartment 52, 54 may be configured to possess its own physical properties (e.g., the particulate material 40 in the cathode compartment 54 may have different properties from the particulate material 40 disposed in the anode compartment 52) through which an aqueous solution can pass without entering adjacent compartment 52. Preferably, the particulate material 40 in the compartment 52 and/or 54 in which the alkali metal halite feed solution (e.g., alkali metal chlorite) is fed comprises the cation exchange material in the hydrogen form or a mixture of cation exchange material and anion exchange material, wherein the majority of the particulate material 40 is the cation exchange material.

In a preferred embodiment, the anode and cathode compartments 52, 54, respectively, are preferably packed with the cation exchange material, and the membrane 56 separating the anode compartment 52 from the cathode compartment 54 is a cation exchange membrane. In this configuration of the two-compartment reactor 50, the alkali metal chlorite feed solution can be fed to either or both compartments to provide an effluent containing chlorous acid, which is then fed to the fixed bed reactor 200.

Referring now to FIG. 4, the three-compartment electrolytic reactor 70 generally comprises an anode compartment 72, a central compartment 74, and a cathode compartment 76. The central compartment 74 is interposed between the anode and cathode compartments 72, 76, respectively, and is separated therefrom by membranes 90 and 92. Each compartment 72, 74, and 76, preferably includes inlets 78, 80, 82, respectively, and outlets 82, 84 and 86, respectively. The anode compartment 72 includes anode 32 and can be optionally filled with the particulate material 40. The cathode compartment 76 includes cathode 34 and can be optionally filled with the particulate material 40. The anode 32 and cathode 34 are in electrical communication with a source of direct current 36 (DC).

In a preferred embodiment, the central compartment 74 comprises particulate material 40, wherein the particulate material 40 comprises the cation exchange material or a mixture of cation exchange material and anion exchange material, wherein the majority of the particulate material 40 is the cation exchange material. In addition, the electrolytic reactor membrane 90 is a cation exchange membrane. During use, it is preferred that the alkali metal chlorite solution is fed through inlet 80 of the central compartment to produce an effluent that is discharged from outlet 86, which is in fluid communication with the fixed bed reactor 200. The effluent discharged from the anode compartment 72 through outlet 84 is preferably in fluid communication with the inlet 80 or outlet 86 prior to entering the fixed bed reactor 200. In this manner, an oxidizing agent generated in the anode compartment 72 is fed into the fixed bed reactor 200, which can be used to regenerate the redox exchange material contained therein. In the case where the effluent from the anode compartment 72 is in fluid communication with the inlet of the central compartment 74, the effluent can be used to dilute the alkali metal feed solution to a desired amount prior to entering the central compartment 74.

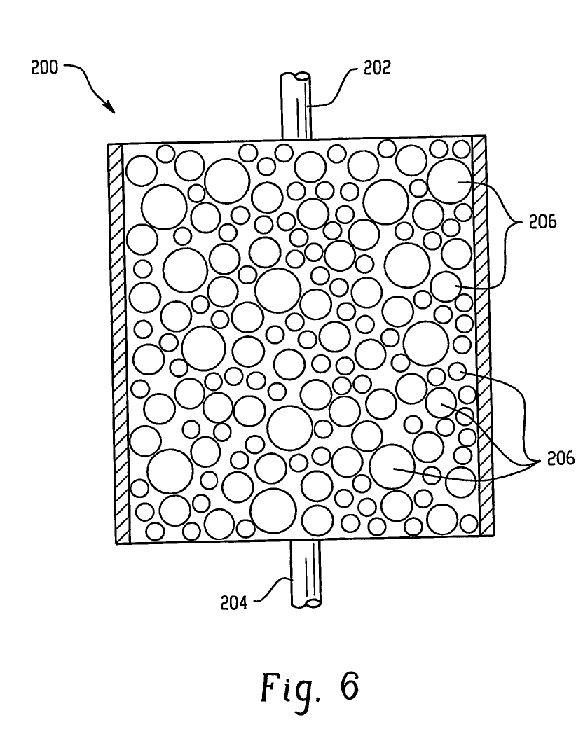

Referring now to FIGS. 5A and 5B, there is shown an exploded isometric view of an exemplary electrolytic reactor cassette 100 employing the three-compartment reactor configuration 70 as described in relation to FIG. 4. The cassette 100 is formed from stock materials that are preferably chemically inert and non-conductive. Components forming the cassette 100 may be molded for high volume production or alternatively, may be machined as described in further detail below.

The exemplary cassette 100 is configured for producing about 5 grams per hour of chlorous acid and is fabricated from two pieces of flat stock 102 and 104, about 4 inches across by about 14 inches long by about 1 inch thick. The pieces 102, 104 are machined such that depressions ¼ inch deep by 2 inches across by 12 inches long are cut in the center of each piece. The pieces 102, 104 are then drilled and tapped to accept the anode 32 and cathode 34. Each piece further includes inlets 78, 82 and outlets 84, 88, through which fluid would flow. The anode 32 and cathode 34 are approximately 2 inches across by 9 inches long and are inserted into the stock pieces 102 and 104. Membranes 90, 92 are disposed over each depression formed in stock pieces 102, 104. Preferably, membrane 90 is a cation exchange membrane. Approximately 150 ml of particulate material (not shown) may optionally be packed into each depression to form the anode compartment 72 and the cathode compartment 76, respectively (as shown in FIG. 4). As constructed, the particulate material, if present in the cathode and/or anode compartments, is configured to be in direct contact with the anode 32 or cathode 34.

Interposed between the membranes 90, 92 is a piece of flat stock 106, about 4 inches across by about 14 inches long by 1 inch thick. The stock piece 106 is machined such that a hole about 2 inches across by 12 inches long is cut through the piece to form the central compartment 74 (as shown in FIG. 4). The piece 106 is then drilled and tapped to accept two fittings that form inlet 80 and outlet 86 through which fluid would flow. The central compartment 74 is filled with about 150 ml of particulate material that includes the cation exchange material. The components of the electrolytic reactor cassette 100 are assembled and bolted together, or otherwise secured. In this configuration, the aqueous alkali metal halite solution (e.g., alkali metal chlorite) is preferably passed through the central compartment 74 and is not in direct contact with the anode 32 or cathode 34.

In a preferred embodiment, the cassette 100 is formed from an acrylonitrile-butadiene-styrene (ABS) terpolymer. Other suitable materials include polyvinylchloride (PVC), chlorinated PVC, polyvinylidene difluoride, polytetrafluoroethylene and other fluoropolymer materials.

While the arrangements of anode, cathode, and electrolytic reactors 30, 50, and 70 illustrated in FIGS. 2, 3, and 4 are presently considered preferable, any arrangement in which a sufficient quantity of cation exchange resin or material is packed between the anode and cathode in an electrolytic reactor or in at least one of the compartments of a divided or multi-compartment electrolytic reactor can be used. Other embodiments include, but are not limited to, separation of the anode and cathode compartments to control intermixing of gases and solutions and provision of any number of packed-bed compartments separated by membranes placed between the anode and cathode to affect other oxidation, reduction or displacement reactions.

The anode 32 and the cathode 34 may be made of any suitable material based primarily on the intended use of the electrolytic reactor, costs and chemical stability. For example, the anode 32 may be made of a conductive material, such as ruthenium, iridium, titanium, platinum, vanadium, tungsten, tantalum, oxides of at least one of the foregoing, combinations including at least one of the foregoing, and the like. Preferably, the anode 32 comprises a metal oxide catalyst material disposed on a suitable support. The supports are typically in the form of a sheet, screen, or the like and are formed from a rigid material such as titanium, niobium, and the like. The cathode 34 may be made from stainless steel, steel or may be made from the same material as the anode 32.

The permselective membranes, e.g., 56, 90, and 92, preferably contain acidic groups so that ions with a positive charge can be attracted and selectively passed through the membrane in preference to anions. Preferably, the permselective membranes contain strongly acidic groups, such as R—SO₃⁻ and are resistant to oxidation and temperature effects. In a preferred embodiment, the permselective membranes are fluoropolymers that are substantially chemically inert to chlorous acid and the materials or environment used to produce the chlorine dioxide. Examples of suitable permselective membranes include perfluorosulfonate cation exchange membranes commercially available under the trade name NAFION commercially available from E.I. duPont de Nemours, Wilmington, Del.

The cation exchange material is preferably an oxidizing exchanger, i.e., a cation ion exchange resin or material. During operation of the electrolytic reactor 20, it is hypothesized that the function of the cation exchange material includes, among others, electro-actively exchanging or adsorbing alkali metal ions from the aqueous alkali metal chlorite solution and releasing hydrogen ions. The released hydrogen ions react with the chlorite ions to form chlorous acid and/or can regenerate the cation exchange material back to the hydrogen form thereby releasing alkali metal ions or the like that may then pass into the cathode compartment, if present. The use of the cation exchange material is especially useful when feeding a dilute alkali metal chlorite solution into the central compartment 74 of the three-compartment electrolytic reactor 70 as it helps lower the voltage within the compartment and increases conversion efficiency. When the cation exchange material reaches its exhaustion point or is near exhaustion, it may be readily regenerated by a strong or weak acid so as to exchange the alkali or alkaline earth metal previously adsorbed by the active sites of the cation exchange material for hydrogen. The acid necessary for regenerating the cation exchange material may be added individually at the compartment inlet or may be generated in the anode compartment, which then diffuses across the cation exchange membrane. The anionic exchange material, if present, may be regenerated by a strong or weak base, e.g., sodium or potassium hydroxide.

Examples of suitable cation exchange resins or materials include, but are not intended to be limited to, polystyrene divinylbenzene cross-linked cation exchangers (e.g., strong acid types, weak acid types, iminodiacetic acid types, chelating selective cation exchangers and the like); strong acid perfluorosulfonated cation exchangers; naturally occurring cation exchangers, such as manganese greensand; high surface area macro-reticular or microporous type ion exchange resins having sufficient ion conductivity, and the like. For example, strong acid type exchange materials suitable for use are commercially available from Mitsubishi Chemical under the trade names Diaion SK116 and Diaion SK104. Optionally, the cation exchange material may be further modified, wherein a portion of the ionic sites are converted to semiconductor junctions, such as described in U.S. Pat. Nos. 6,024,850, 5,419,816, 5,705,050 and 5,609,742, herein incorporated by reference in their entireties. However, the use of modified cation exchange material is less preferred because of the inherent costs associated in producing the modification. In a preferred embodiment, the cation exchange materials have a cross-linking density greater than about 8%, with greater than about 12% more preferred and with greater than about 16% even more preferred. Increasing the cross-linking density of the cation exchange materials has been found to increase the resistance of the cation exchange materials to effects of the electrolytic environment such as oxidation and degradation. As a result, operating lifetimes for the electrolytic reactor can advantageously be extended.

The packing density and conductivity of the particulate material 40 disposed within a compartment can be adjusted depending on the operating parameters and desired performance for the electrolytic reactors 30, 50, 70. For example, the particulate material may be shrunk before use in the electrolytic reactor, such as by dehydration or electrolyte adsorption. Dehydration may be by any method in which moisture is removed from the ion exchange material, for example, using a drying oven. It has been found that dehydration prior to packing can increase the packing density by as much as 40%. Electrolyte adsorption involves soaking the material in a salt solution, such as sodium chloride. The packing density of the material so treated can be increased by as much as 20%. The increase in packing density advantageously increases the volume in which the DC current travels, thus reducing the electrical resistance in the electrolytic reactor.

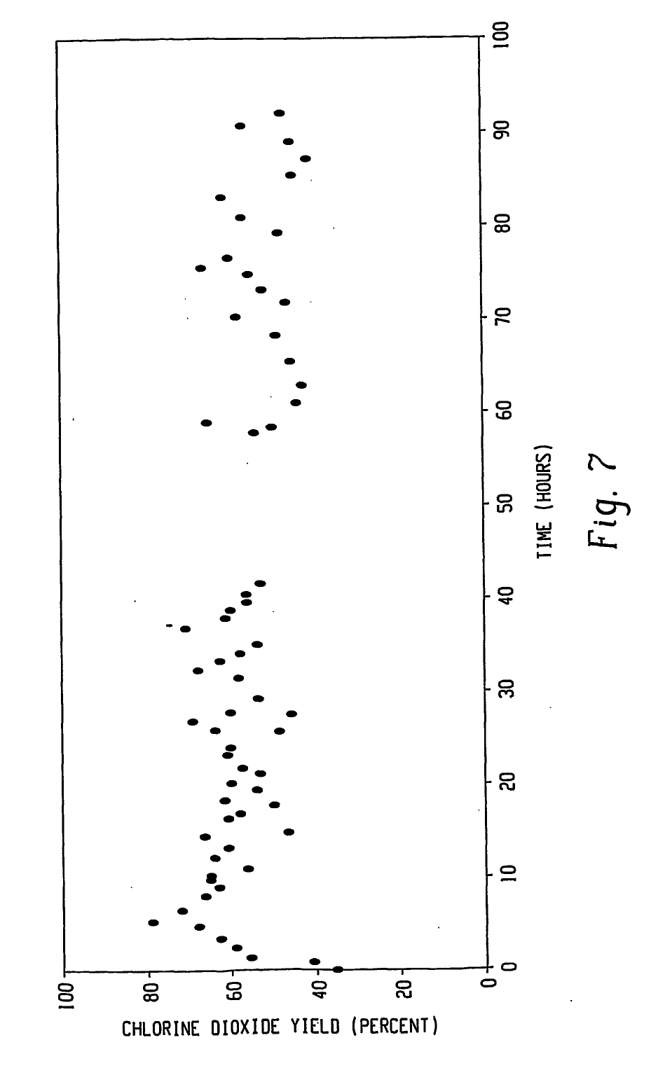

Referring now to FIG. 6, there is illustrated a fixed bed reactor 200 having an inlet 202 and an outlet 204. Disposed within the fixed bed reactor is a bed containing the redox exchanger material 206. As used herein, the term “redox exchanger material” refers to conjugate oxidizing and reducing materials that contain both oxidation and reduction couples. That is, the redox exchanger material can be used to oxidize and/or reduce dissolved ionic species in a solution. One type of suitable redox exchanger material includes those referred to as reversible redox agents. Other types of redox exchanger materials include modified ion exchange resins, which have been modified to include the oxidation and reduction couple. The reversible oxidation-reduction couples are held in the resin either as counter ions, by sorption, or by complex formation.

The reversible redox exchange materials are capable of reversing the oxidation and/or reduction state of the redox exchanger material after oxidizing or reducing a species. That is, the redox agent after having oxidized (or reduced) a species can be regenerated by a suitable oxidation (or reduction) agent. The reactivity of these agents is due to the functional groups present, which can be reversibly oxidized or reduced. These types of redox agents do not carry fixed ionic groups and contain no counter ions within their matrix that would function as an ion exchanger. Suitable examples of redox exchanger materials include, but are not intended to be limited to, manganese greensand, those redox exchanger agents commercially available under the trademarks BIRM, PYROLOX and MTM from the Clack Corporation, and KDF-85 from KDF Fluid Treatment, Inc. BIRM is a manufactured medium consisting of granular material coated with magnesium oxide; MTM and PYROLOX are mineral forms of manganese dioxide; and KDF-85 is a copper-zinc type redox media.

In the oxidized state, the redox exchanger materials can oxidize dissolved ionic species (e.g., chlorous acid) provided that the redox potential of the ionic species is greater than that of the redox exchanger, i.e., the oxidation-reduction couple on the redox exchanger must be a stronger oxidizing agent than the oxidized ionic species. Since the process is reversible due to the nature of the redox agent, the redox agent becomes oxidized when in contact with an oxidizing agent, such as, for example, upon contact with oxygen that has been generated by electrolysis of water at the anode. The coupling agents are preferably metal complexes, wherein the metal is capable of having reversible oxidation states. Suitable metals include titanium, ruthenium, vanadium, platinum, iridium, gold, copper, chromium, manganese, iron, cobalt, nickel, zinc, composites or mixtures or alloys or oxides of at least one of the foregoing metals, and the like.

The flow rate through the fixed bed reactor is preferably about 1 to about 10 gallons per minute/square foot (gpm/ft²), with about 2 to about 5 gpm/ft² more preferred. The minimum bed depth is preferably about 24 inches. The flow rate and minimum bed depth can be used to determine the dimension of the fixed bed reactor and the volume of redox exchanger material employed.

The particulate material 40 of the electrolytic reactor 20 and the redox exchanger material 206 of the fixed bed reactor 200 are not intended to be limited to any particular shape. Suitable shapes include rods, extrudates, tablets, pills, irregular shaped particles, spheres, spheroids, capsules, discs, pellets or the like. In a preferred embodiment, the particulate material is spherical. More preferably, the particulate material includes a reticulated and textured surface having an increased surface area. The sizes of the particulate material 40 and redox exchanger materials 206 employed in the system 10 are dependent on the acceptable pressure drop across the respective bed. The smaller the particulate material 40 or redox exchanger material 206, the greater the pressure drop.

In the preferred application for generating chlorine dioxide, the system 10 is configured with the three-compartment electrolytic reactor 70 as previously described, wherein the central compartment outlet 86 is in fluid communication with the fixed bed reactor inlet 202. The three-compartment reactor 70 preferably comprises a cation exchange membrane 90 separating the anode compartment 72 from the central compartment 74. Cation exchange material is preferably disposed in the central compartment 74.

In operation of the preferred application, a dilute aqueous feed solution of an alkali metal chlorite solution is passed through the central compartment 74. The alkali metal ions are exchanged with hydrogen ions of the cation exchange material to produce chlorous acid within the central compartment 74. Water preferably flows through the anode and cathode compartments 72, 76, respectively. Preferably, the water is deionized.

As a direct current is applied to the reactor 70, the anode compartment 72 oxidizes the water to generate, among others, hydrogen ions and oxygen (O₂) whereas the cathode compartment 76 reduces the water to generate, among others, hydroxyl ions. The hydrogen ions generated in the anode compartment 72 can diffuse across the cation exchange membrane 90 into the central compartment 74 to regenerate the cation exchange resin within the central compartment 74 and/or to acidify the chlorite ions to produce chlorous acid.

The chlorous acid effluent from the reactor 70 is fed to the fixed bed reactor 200, wherein chlorous acid is oxidized by the redox exchange material to chlorine dioxide. The oxygen generated by electrolysis of water in the anode compartment 72 can be used to dilute the alkali metal chlorite feed solution as it is introduced into the central compartment 74 or may be combined with the chlorous acid containing effluent from the central compartment 74 prior to being fed to the fixed bed reactor 200.

The concentration of chlorous acid produced by the electrolytic reactor, e.g. 10, 100, is preferably less than about 6.0 grams per liter (g/L), with less than about 3 g/L more preferred and less than about 0.65 g/L even more preferred. Also preferred is a chlorous acid concentration greater than about 0.06 g/L, with greater than about 0.3 g/L more preferred and greater than about 0.5 g/L even more preferred. At concentrations greater than about 6.0 g/L, there is an increased risk of producing chlorine dioxide in the vapor phase as the chlorous acid solution is oxidized in the fixed bed reactor 200, which undesirably can cause an explosion referred to by those skilled in the art as a “puff”.

The applied current to the reactor 100 should be sufficient to reduce the pH of the resulting chlorous acid effluent solution to less than about 7. More preferably, the pH is reduced to about 1 to about 5, with a reduction of pH to about 2 to about 3 most preferred. The alkali metal ions from the alkali metal chlorite solution can diffuse through membrane 92 to the cathode compartment 76 and with the hydroxyl ions produce an alkali metal hydroxide effluent from the cathode compartment 76.

There are a number of variables that may be optimized during operation of the system 10. For example, a current density for the electrolytic reactors is preferably maintained at about 5 to about 100 milliAmps per square centimeter (mA/cm²). More preferably, the current density is less than about 50 mA/cm², with less than about 35 mA/cm² even more preferred. Also preferred, are current densities greater than about 10 mA/cm², with greater than about 25 mA/cm² more preferred. The temperature at which the feed solutions (e.g., alkali metal chlorite solution, water, and the like solutions) is maintained can vary widely. Preferably, the temperature is less than about 50° C., with less than about 35° C. more preferred and with less than about 25° C. even more preferred. Also preferred is a temperature greater than about 2° C., with greater than about 5° C. more preferred, and with greater than about 10° C. even more preferred. In a preferred embodiment, the process is carried out at about ambient temperature.

In addition to temperature and current density, the contact time of the alkali metal chlorite solution with the cation exchange material is preferably less than about 20 minutes and more preferably, less than about 2 minutes. Also preferred is a contact time greater than about 1 minute, with greater than about 0.1 minute more preferred. Similarly, the contact time of the chlorous acid containing effluent with the redox exchanger material is preferably less than about 20 minutes and more preferably, less than about 2 minutes. Also preferred is a contact time greater than about 1 minute, with greater than about 0.1 minute more preferred. The velocity of the chlorine dioxide precursor solution through the electrolytic reactor and/or fixed bed reactor is preferably less than about 100 centimeters/minute (cm/min), with less than about 70 cm/min more preferred and less than about 30 cm/min more preferred. Also preferred is a velocity greater than about 0.1 cm/min, with greater than about 10 cm/min more preferred and with greater than about 20 cm/min even more preferred. The pressure drop through the electrolytic reactor and/or fixed bed reactor is preferably less than about 20 pounds per square inch (psi) and for most applications, with less than about 10 psi more preferred. Also preferred is a pressure drop greater than about 0.1 psi, and for most applications, with greater than about 1 psi more preferred. Further optimization for any of these process variables is well within the skill of those in the art in view of this disclosure.

The disclosure is further illustrated by the following non-limiting Examples.

### EXAMPLE 1

In this Example, a system for generating chlorine dioxide was configured as described in FIG. 1.

The electrolytic reactor was configured as shown and described in FIG. 4. Each compartment employed a length of 25.4 centimeters (cm) with a width of 5.08 cm. The thickness of the central compartment was 1.27 cm and the thicknesses of the electrode compartments were 0.64 cm. The electrode and central compartments of the electrolytic reactor contained SK116 cation exchange resin commercially available from Mitsubishi Chemical. A transverse DC electric field was supplied by an external power supply to the electrodes. The effluent from the anode compartment was coupled to the inlet of the central compartment, thereby diluting a 25-weight percent sodium chlorite feed solution such that the final concentration of sodium chlorite was about 1000 mg/L as it entered the central compartment. The temperature of the feed solution was held constant at about 30° C.

Softened water was passed upwardly through the anode and cathode compartments of the electrolytic reactor at a flow rate of about 50 mL/min. While passing the solutions through the compartments of the reactor, a controlled current of about 8.0 amps was applied to the anode and cathode.

The fixed bed reactor was configured as shown in FIG. 6 and had a diameter of 3.46 cm and length of 60.96 cm. The fixed bed reactor was filled with 575 milliliters of manganese greensand with an operating capacity of about 300 grains manganese per cubic foot. The manganese greensand had an effective particle size of about 0.030 millimeters to about 0.35 millimeters. The inlet conduit of the fixed bed reactor was coupled to the central compartment outlet of the electrolytic reactor. Thus, the fixed bed reactor received an effluent from the electrolytic reactor containing both chlorous acid and oxygen. The system was operated continuously for a period of 100 hours.

A Direct Reading Spectrophotometer, Model No. DR/2000, was used to measure the chlorine dioxide concentration (mg/L) in the solution exiting the fixed bed reactor using Hach Company Method 8138. Measurement of the yield provides a standard for evaluating actual performance of the system and can be determined in accordance with the following mathematical relationship:

$$\% Yield = \frac{actual}{theoretical} \times 100$$

wherein the actual yield is determined from the amount of chlorine dioxide generated, and wherein the theoretical yield is calculated by the amount of chlorine dioxide that could be generated from the sodium chlorite solution. The theoretical yield can be calculated as follows:

$$\% Theoretical Yield = \frac{{[ {ClO}_{2} ]}_{product}}{{θ [ {NaClO}_{2} ]}_{feed} [ \frac{90.5}{67.5} ]} \times 100$$

wherein the term (90.5/67.5) is the ratio of the equivalent weight of the sodium chlorite to chlorine dioxide. The symbol “θ” represents the stoichiometric ratio between the chlorine dioxide product and sodium chlorite reactant, which can vary from 0.8 to 1.0 depending on the reactants used and the stoichiometry of the reaction.

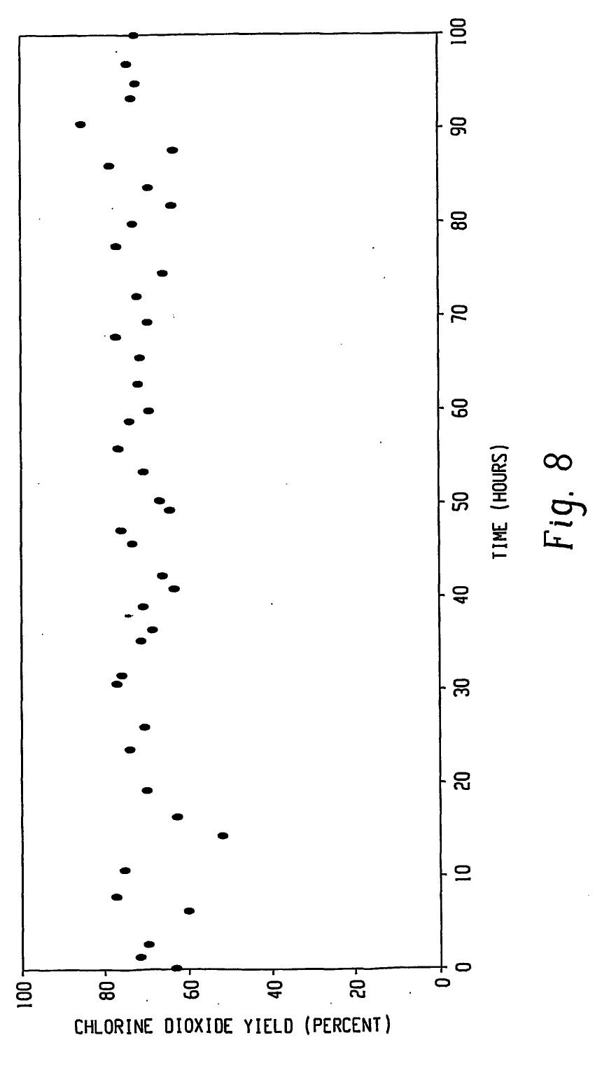

FIG. 7 graphically depicts the conversion efficiency as a function of time for the system. Initially, it is shown that the conversion efficiency to oxidize chlorite ions to chlorine dioxide was relatively low. This was expected since manganese greensand employed was not initially in the fully oxidized “regenerated” form. After about 10 hours of operation conversion of chlorite solution to a chlorine dioxide solution was at about the maximum theoretical yield. Increased conversion efficiencies over a prolonged period of time are a significant commercial advantage since it reduces the maintenance and operating costs of these reactors significantly. Moreover, the fixed bed reactor is regenerated as demonstrated by its efficiency over the 100-hour testing period (See Comparative Example below).

### EXAMPLE 2

In this Example, the system as described in Example 1 was employed, wherein the fixed bed reactor was filled with 575 ml of PYROLOX that had an effective particulate size of about 0.51 millimeters. The temperature of the sodium chlorite feed solution was about 20° C.

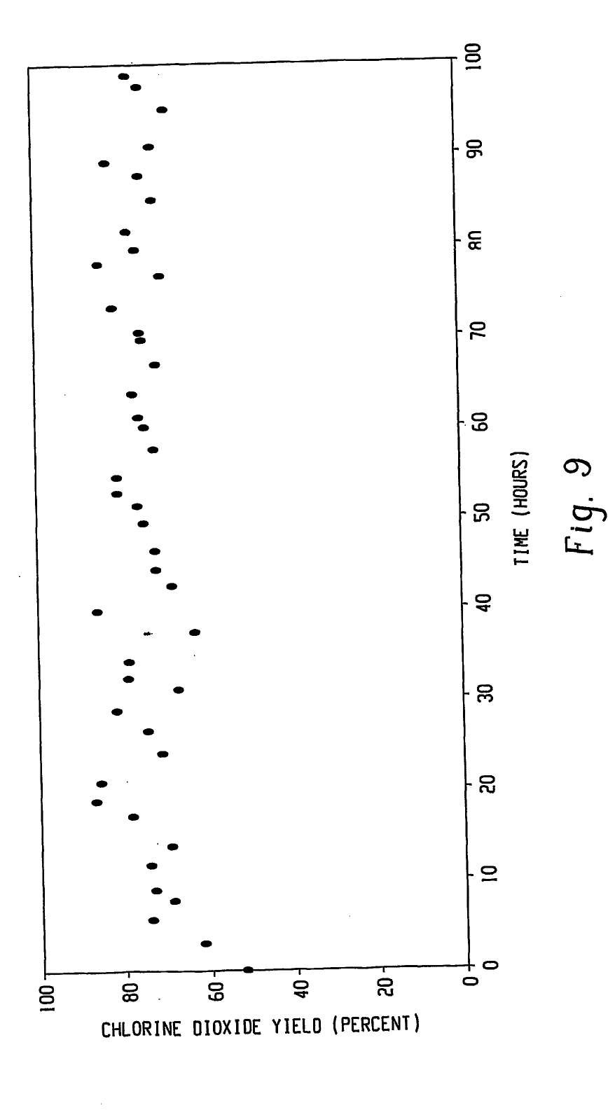

FIG. 8 graphically depicts the conversion efficiency as a function of time for the system. Conversion efficiency was at about theoretical maximum.

### EXAMPLE 3

In this Example, the system as described in Example 1 was employed, wherein the fixed bed reactor was filled with 575 ml of BIRM with an effective particulate size of about 0.48 millimeters. The temperature of the sodium chlorite feed solution was at about 20° C.

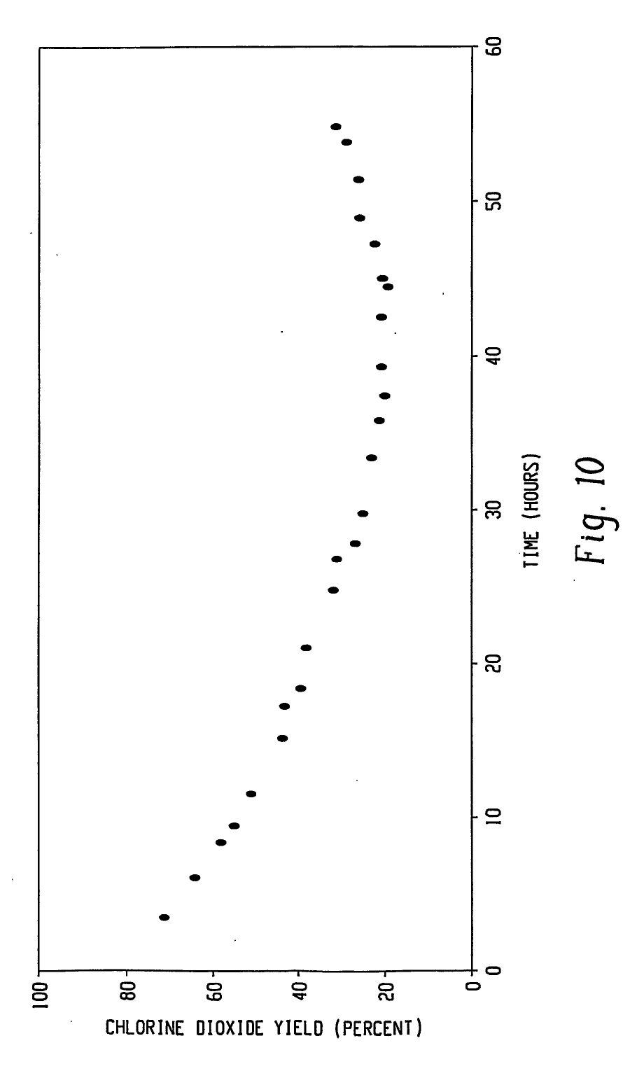

FIG. 9 graphically depicts the conversion efficiency as a function of time for the system. Conversion efficiency was at about theoretical maximum.

### COMPARATIVE EXAMPLE

In this Comparative Example, the system as described in Example 1 was employed, wherein the oxygen generated in the anode compartment was not fed to the inlet of the central compartment. Thus, the effluent introduced to the fixed bed reactor in contained chlorous acid and did not include the effluent produced in the anode compartment.

FIG. 10 graphically depicts the conversion efficiency as a function of time for the system. Conversion efficiency significantly and steadily decreased as the system was operated indicating that regeneration of the manganese greensand did not occur to the extent regeneration occurred in Examples 1-3. The conversion efficiency stabilized to approximately 20% after about 30 hours of operation. While not wanting to be bound by theory, it is believed that oxygen levels normally present in water (prior to electrolysis) provided some regeneration to the manganese greensand and was likely one of the reasons why the conversion efficiency did not decrease to zero. At about 40 hours, the effluent (O₂ containing) produced in the anode compartment was added to the chlorous acid feed. A slight increase was seen in the conversion efficiency, but did not increase back to its original level. It is believed that since there was no oxidizing agent combined with the chlorous acid effluent introduced to the fixed bed reactor to cause regeneration of the manganese greensand during the first 40 hours of operation, the continuous flow of chlorous acid solution through the fixed bed reactor at low pH resulted in an ion exchange of manganese and hydrogen ions. Desorption of the manganese will also cause a decrease in redox capacity.

While the disclosure has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the disclosure without departing from the essential scope thereof, such as for producing other halogen oxides. Therefore, it is intended that the disclosure not be limited to the particular embodiment disclosed as the best mode contemplated for carrying out this disclosure, but that the disclosure will include all embodiments falling within the scope of the appended claims.

1. A system comprising:
an electrolytic reactor comprising a compartment having an inlet and an outlet, an anode, a cathode, and a particulate material disposed between the cathode and the anode, wherein the particulate material comprises a cation exchange material;
a source of direct current in electrical communication with the anode and the cathode; and
a fixed bed reactor comprising a chamber having an inlet and an outlet, wherein the fixed bed reactor chamber contains a redox exchanger material, and wherein the fixed bed reactor inlet is in fluid communication with the electrolytic reactor outlet.

2. The system according to claim 1, wherein the electrolytic reactor further comprises an anode compartment, a cathode compartment and a central compartment interposed between the cathode and anode compartments, wherein a cation exchange membrane separates the cathode compartment from the central compartment, and wherein the particulate material is disposed in the central compartment.

3. The system according to claim 1, wherein the particulate material comprises a mixture of cation exchange material and an anion exchange material, wherein a majority of the particulate material is the cation exchange material.

4. A process for producing halogen oxide, the process comprising:
feeding an aqueous alkali metal halite solution into an electrolytic reactor to produce an effluent containing halous acid;
feeding the halous acid containing effluent into a fixed bed reactor containing a redox exchanger material; and contacting the halous acid containing effluent with the redox exchanger material to produce a halogen oxide.

5. The process according to claim 4, wherein the alkali metal halite solution consists of an alkali metal chlorite to produce an effluent containing chlorous acid, and chlorine dioxide upon contact with the redox exchanger material.

6. The process according to claim 5, wherein the aqueous alkali metal chlorite solution contains less than about 10,000 milligrams alkali metal chlorite per liter of solution.

7. The process according to claim 5, wherein the aqueous alkali metal chlorite solution contains less than about 5,000 milligrams alkali metal chlorite per liter of solution.

8. The process according to claim 5, wherein the aqueous alkali metal chlorite solution contains less than about 1,500 milligrams alkali metal chlorite per liter of solution.

9. The process according to claim 5, further comprising feeding an oxidizing agent to the fixed bed reactor to regenerate the redox exchanger material.

10. The process according to claim 9, wherein the oxidizing agent is produced by electrolysis of water in the electrolytic reactor.

11. A process for producing chlorine dioxide from an alkali metal chlorite solution, the process comprising:
applying a current to an electrolytic reactor, wherein the electrolytic reactor includes an anode compartment comprising an anode, a cathode compartment comprising a cathode, and a central compartment positioned between the anode and cathode compartments, wherein the central compartment comprises a cation exchange material and is separated from the cathode compartment with a cation exchange membrane;
feeding the alkali metal chlorite solution to the central compartment;
electrolyzing water in the anode compartment to produce an oxygen containing effluent;
exchanging the alkali metal ions with hydrogen ions to produce a chlorous acid containing effluent from the central compartment;
combining the chlorous acid effluent with the oxygen containing effluent and feeding the combined effluents to the fixed bed reactor; and
oxidizing the chlorous acid with a redox exchanger material in the fixed bed reactor to produce chlorine dioxide and regenerating the redox exchanger material.

12. The process according to claim 11, wherein the alkali metal chlorite solution is selected from the group consisting of lithium chlorite, sodium chlorite and potassium chlorite.

13. The process according to claim 11, wherein the effluent containing the chlorous acid has a pH of about 1 to about 5.

14. The process according to claim 11, wherein the alkali metal chlorite solution contacts the cation exchange material for a time of about 0.1 to about 20 minutes.

15. The process according to claim 11, wherein the redox exchange material comprises a shape selected from the group consisting of rods, extrudates, tablets, pills, irregular shaped particles, spheres, spheroids, capsules, discs, pellets, and a combination of at least one of the foregoing shapes.

16. The process according to claim 11, the cation exchange material is selected from the group consisting of strong acid polystyrene divinylbenzene crosslinked resins, weak acid polystyrene divinylbenzene crosslinked resins, iminoacetic acid polystyrene divinylbenzene crosslinked chelating selective cation exchange resins, synthetic inorganic cation exchangers and naturally occurring cationic exchangers.

17. The process according to claim 11, wherein the cation exchange material has a crosslinking density greater than or equal to about 16%.

18. The process according to claim 11, wherein the current applied to the anode and cathode is at a current density of about 5 to about 100 milliAmps per square centimeter.

19. A process for producing chlorine dioxide from an alkali metal chlorite solution, the process comprising:
applying a current to an electrolytic reactor, wherein the electrolytic reactor includes an anode compartment comprising an anode, a cathode compartment comprising a cathode, and a central compartment positioned between the anode and cathode compartments, wherein the central compartment comprises a cation exchange material and is separated from the cathode compartment with a cation exchange membrane;
flowing a solution comprising water in the anode compartment to produce an oxygen containing effluent;
diluting an alkali metal chlorite solution with the oxygen containing effluent;
feeding the diluted alkali metal chlorite solution to the central compartment;
exchanging the alkali metal ions with hydrogen ions to produce a chlorous acid and oxygen containing effluent in the central compartment;
feeding the effluent to a fixed bed reactor containing a redox exchanger material; and
contacting the effluent with the redox exchanger material in the fixed bed reactor to produce chlorine dioxide and continuously regenerate the redox exchanger material.

20. A process for regenerating a fixed bed reactor containing a redox exchanger material, the process comprising:
electrolyzing water in an electrolytic reactor to produce an oxygen containing effluent; and
flowing the oxygen containing effluent into the fixed bed reactor to regenerate the redox exchanger material.
